(19) United States
(12) Patent Application Publication
(10) Pub. No.: US 2009/0159406 A1
(43) Pub. Date: Jun. 25, 2009

(54) WEAR BAR ARRANGEMENT FOR CHAIN DRIVE IN DRYER

(76) Inventor: Wayne Crooks, Madison, OH (US)

Correspondence Address: PEARNE & GORDON LLP, 1801 EAST 9TH STREET, SUITE 1200, CLEVELAND, OH, 44114-3108, US

(21) Appl. No.: 11/959,484

(22) Filed: Dec. 19, 2007

(51) Int. Cl. B65G 21/20

(52) U.S. Cl. 198/837

(57) ABSTRACT

A hold down device for positioning the drive chain of a roller conveyor in a dryer comprising a mounting bracket, and a wear bar, the mounting bracket being arranged to be mounted on a horizontally extending rigid frame member and having a configuration enabling it to support the wear bar over the path of the reach of a roller chain that is meshed with drive sprockets that are each associated with a respective roller of the conveyor, the mounting bracket being arranged to locate the wear bar in an operative position immediately overlying the chain while the chain is meshed with the roller sprockets, the wear bar being removably mounted on the mounting bracket. In one embodiment the wear bar is an elongated element having a width adapted to be received in the space between a pair of links separated by a roller of the drive chain. The elongated wear bar is carried on a guide which in turn is supported directly on the mounting bracket. The elongated wear bar and guide have complementary slots which, with aligned grooves on the wear bar, permit a simple slip-in self-aligning assembly of the wear bar on the guide. In another embodiment, the wear bar integrates the structure and function of the guide.

### BACKGROUND OF THE INVENTION

The invention relates to improvements in roller conveyors for dryers used in the production of boards.

Power driven roller conveyors are used in the board making industry to transport wet raw material through a hot air dryer to draw out excess moisture. Ordinarily, the rollers of the same level or deck are driven by a common chain trained over a series of sprockets each driving an associated roller. Customarily, the chain is guided along an operating path by so-called hold-downs or drags. Typically, several hold-downs are spaced along the path of a chain. The hold-downs keep a reach of chain engaged with the roller sprockets by holding it down against upward movement which might otherwise permit it to slip off a sprocket or sprockets. Additionally, the hold downs serve to guide the reach of a chain operating in the deck above it on its return path where it is out of engagement with its associated sprockets. In this function, the hold down carries a part of the weight of the chain where it tends to sag. The hold downs, in addition to vertically locating the drive chain, are typically employed to horizontally locate and constrain the drive chain.

Constant sliding action of the chain on the hold downs eventually wears the hold downs to a point where they cannot reliably serve to constrain and locate the drive chain. Consequently, the hold downs must be periodically replaced. This replacement can be required perhaps once a year, depending on the service conditions. As far as known, the prior art hold downs have been monolithic or one-piece units that typically are a ferrous casting that include mounting features and associated bracketry. The various parts of the prior art hold down units thus serve to dispose the chain engaging surfaces in the proper place while enabling the units to be attached to nearby rigid frame members of the dryer. The hold units heretofore ordinarily have been entirely replaced when the actual chain locating surfaces or surfaces surrounding these elements have been effectively worn away.

### SUMMARY OF THE INVENTION

The invention involves a multiple part hold down device for positioning the drive chain in a roller conveyor system of a dryer. The hold down device includes a wear bar that can be removed and replaced when its service life has been expended. The removal and replacement of the disclosed wear bar can be readily accomplished with considerable savings in material and costs when compared to prior art products since, in accordance with the invention, only the part of the hold down that ordinarily experiences wear need be replaced and the replacement part is of a relatively plain geometry. Thus, considerable savings can be realized in the cost of manufacture and ultimate replacement of this part.

In one illustrated embodiment, the wear replacement part is an elongated element that can be advantageously fashioned from a rectangular bar such as ductile bar. This wear bar element can be configured to fit in a complementarily shaped zone in a receiving part of the hold down device. The fit between the wear bar and receiving zone is arranged so that these elements are self-aligning and minimal fastening effort is required. Still further, the hold down device, apart from the wear bar, can be made in two other parts, thereby allowing the device to be fitted on different dryer constructions while using common parts of the hold down device. Moreover, in instances, where the dryer has incurred excessive or extraordinary wear, only a limited portion of the hold down device need be replaced rather than the full extent of the hold down device.

In a second embodiment of the invention, the hold down device comprises two principle parts. One part is replaceable after wear exhausts its service life, and the other part, once installed, is normally a lifetime component of the conveyor system. The replaceable wear bar part and the permanent support bracket part have complementary configurations that enable the wear bar to be locked in an operative position or be released by manipulation of a simple locking member.

Both disclosed embodiments afford economic savings to the manufacturer and user of the hold downs. The wear bar has a configuration that can be used in numerous dryer conveyor models so that inventory requirements can be reduced. The wear bar can be constructed of a material while slightly more expensive, is substantially more wear resistant than that conventionally used thereby yielding a longer service life at lesser overall cost.

### BRIEF DESCRIPTION OF THE DRAWINGS

FIG. 1 is a somewhat schematic fragmentary perspective view of a deck of a dryer having a plurality of rolls for conveying material being dried for forming boards;

FIG. 2 is a fragmentary cross-sectional view of the sprocket side of the roller conveyor of one deck of the dryer illustrating an end view of a hold down device constructed in accordance with a first embodiment of the invention;

FIG. 3 is a plan view of a guide portion of the hold down device of FIG. 2;

FIG. 4 is an end view of the guide portion;

FIG. 5 is a side view of a gooseneck portion of the hold down device as it would appear from a view from the inside of the dryer;

FIG. 6 is a top view of a wear bar portion of the hold down device of the first embodiment;

FIG. 7 is an end view of the wear bar;

FIG. 8 is a side view of the wear bar;

FIG. 9 is a view like FIG. 2 showing a modified hold down device constructed in accordance with a second embodiment of the invention; and

FIG. 10 is a plan view of a wear bar of the embodiment of FIG. 9.

### DESCRIPTION OF THE PREFERRED EMBODIMENT

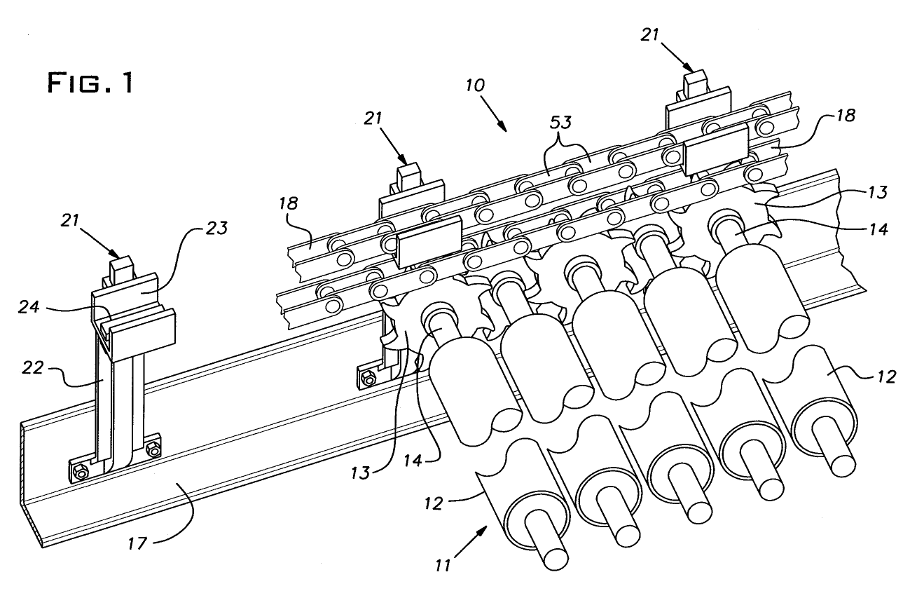

FIG. 1 illustrates a portion of one conveyor level or deck of an example of a multi-deck hot air dryer 10 in which the invention can be employed. As is conventional, the conveyor, designated 11, has a plurality of horizontally disposed rollers 12 parallel to and uniformly spaced from one another. The rollers 12 are rotated under power through associated sprockets 13 fixed on shaft extensions 14. The shaft extensions 14 are each carried in a respective bearing 16 which bearings are collectively supported on a frame element sometimes called a cage angle 17. In a known manner, the sprockets 13 are rotated in unison by a common power transmission chain 18 arranged in an endless loop.

A chain hold down device 21, duplicated at stations along the conveyor 11 separated, for instance, over a spacing of about every five or so rollers 12. The held down devices 21 guide and constrain the chain 18 so that it stays engaged with the sprockets 13. Additionally, the hold down devices 21 support a stretch of another chain 18 for the deck of rollers above the illustrated deck which passes above the sprockets 13 on its return path. As mentioned, a conventional dryer 10 has a plurality of vertically spaced flights or decks so that ordinarily, apart from the uppermost deck, a hold down device 21 serves to guide two chains, a reach of chain under tension and driving a set of sprockets below its guide surfaces and a reach of chain on its return path on the upper side of the guide area of the hold down device 21.

The illustrated hold down device 21 in this first embodiment is an assembly of three principle parts comprising a gooseneck mounting bracket 22, a guide 23, and a wear bar 24. The gooseneck 22 and guide 23 can be ferrous castings suitably machined, if necessary, to mate with flat surfaces, to accept threaded fasteners, and/or to remove flash. In the present disclosure, parts of the various elements are described in their operating orientation. A base 26 of the gooseneck 22 has a flat vertical surface 27 adapted to abut the cage angle 17. A pair of horizontally spaced holes 28, in the base 26, accept bolts 25 that are received in aligned holes in the cage angle 17 to fix the hold down device 21 in the installed operating position illustrated in FIG. 1. An upright section 29 of the gooseneck 22 extends vertically from the base 26 and terminates at a mounting lug or post 31. The mounting lug 31 preferably has a rectangular cross-sectional shape (which expression includes a square shape) when seen in plan view. The mounting lug 31 is flanked by horizontal shoulder surfaces 32 and vertical surfaces 33 formed on the upright section or extension 29.

The guide 23 has the general shape of a short channel with a central web 36 and a pair of parallel flanges 37 that extend upwardly from the web 36. The ends of the flanges are formed with generous bevels 38 to urge the chain 18 into the center of a pocket formed between the flanges 37. At one side, the guide 23 has an integral rectangular U-shaped bracket 39, the center of which is sized with its internal surfaces in a rectangular array to fit closely on the rectangular mounting lug 31. When the guide bracket 39 is assembled on the lug 31, its lower horizontal surface 41 can abut the horizontal surfaces 32 and vertical surfaces 33 at the upper or distal end of the gooseneck extension 29. The guide 23 is removably fixed in position on the gooseneck 22 with a set screw 42 threaded in the bracket 39. The axis of the set screw 42 is parallel to the axis of the rollers 12 so that it is easily engaged with a wrench from outside the chain side of the conveyor 11.

The wear bar 24 is supported by the guide 23 at the center of the web 36 so that it is disposed midway between the planes of the guide flanges 37. The wear bar 24 is an elongated element having top, bottom, and side wear surfaces 46, 47, and 48, respectively. The top and bottom wear surfaces 46, 47, lie in parallel horizontal planes and the side surfaces 48 lie in spaced vertical planes. Ends 51, 52 of the wear bar 24 are beveled or rounded to ensure that a chain 18 will slide smoothly over the top, bottom, and sides 46, 47, and 48, respectively. The chain 18 is of the roller-type commercially available and well-known in the art. By way of example, the chain may have a pitch of 2.609 inch, a roller length of 1 inch and a roller diameter of 1 inch. The chain links can be, for example 1-¼ inch wide and ¼ inch thick. The horizontal width of the wear bar 24 is proportioned to provide a relatively loose sliding fit between the links 53 of the chain 18.

The wear bar 24 and guide 23 can have the same nominal length. The wear bar 24 has a longitudinal slot 54 complementary in length to a slot 56 in the web 36 of the guide 23 such that the combined lengths of the slots is essentially the same as the lengths of the wear bar and guide. The wear bar 24 also has opposed grooves 57 on opposite sides and vertically aligned with the slot 54. The portion of the length of the wear bar 24 where the slot 54 exists is characterized by two parallel tines 58 each of generally rectangular cross-section when viewed in a longitudinal direction. On the part of the length of the wear bar 24 formed with the grooves 57, the wear bar has an I-shaped cross-section with flanges of unequal thickness. The slot 54 extends along approximately one-half the length of the wear bar 24 and, similarly, the slot 56 extends approximately one-half the length of the guide web 36. These slot proportions enable the wear bar 24 to be fully received onto the web 36 from its slotted end such that the unslotted half of the web is received in the slot 54 of the wear bar 24 and, vice versa, the unslotted half of the wear bar is received in the slot 56 of the guide web. The slots 54, 56 and grooves 57 are proportioned to give a sliding fit between the wear bar 24 and guide 23 when the wear bar is received on the guide, but with limited clearance so that the wear bar is accurately located and aligned with the path of the chain 18.

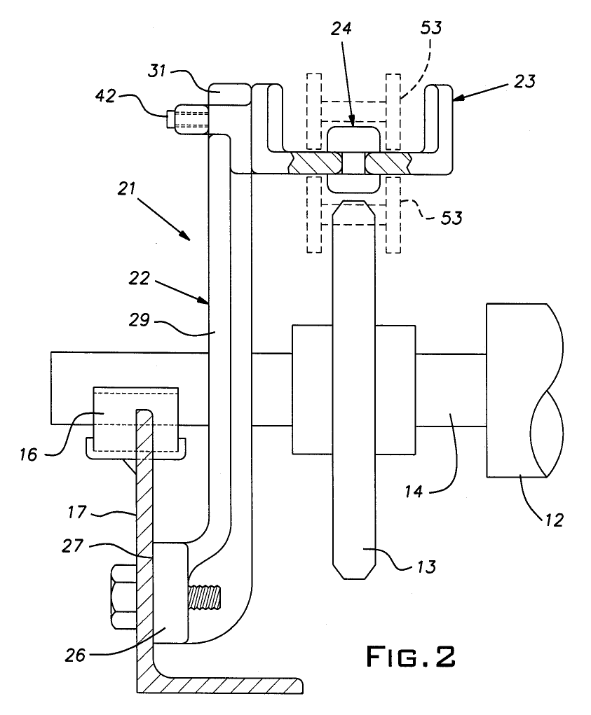

As shown in FIGS. 1 and 2, the hold down device 21 is configured to position the wear bar 24 above and in a common vertical plane with the sprockets 13.

The wear bar 24 has a width generally equal to the width of the sprockets 13 at the base of their teeth, and a length, for example, of at least one chain pitch length and, more preferably, at least about 1-½ times the pitch length of the chain. This length of the wear bar 24 ensures that it is always serving to support at least one chain roller. The wear bar 24 can be retained on the guide 23 by, for example, a roll pin received in aligned holes 61, 62 drilled in both the wear bar and guide. The wear bar 24 can be economically fabricated from ductile iron cast bar stock or cast steel having a rectangular cross-section (the term rectangular including square) adequate to form the disclosed shape with minimal external machining. With the grooves 57 offset from the vertical mid-plane of the wear bar 24, the wear bar's orientation can be inverted as needed to suit the geometry of a particular conveyor.

The invention capitalizes on the local character of the wear pattern developed by the chain 18 on the hold down device 21. Wear occurs primarily at the top and lower faces of the disclosed wear bar 24. Thus, in accordance with the invention, replacement of the wear bar 24 serves to restore the device to essentially new condition. The spent wear bar 24 is removed by simply knocking out the roll pin and sliding the wear bar out of the guide slot 56. A new wear bar 24 is installed just as simply by sliding a new one into the slot 56 and driving a roll pin in place. Numerous economic and environmental advantages are realized where only a small fraction of the hold down device need be replaced to essentially completely refurbish it. This can be especially appreciated by considering that a given dryer may typically have literally hundreds of hold downs and it is not unusual for wear, due to sliding friction of the chain, to require all of the hold downs be replaced every year or so.

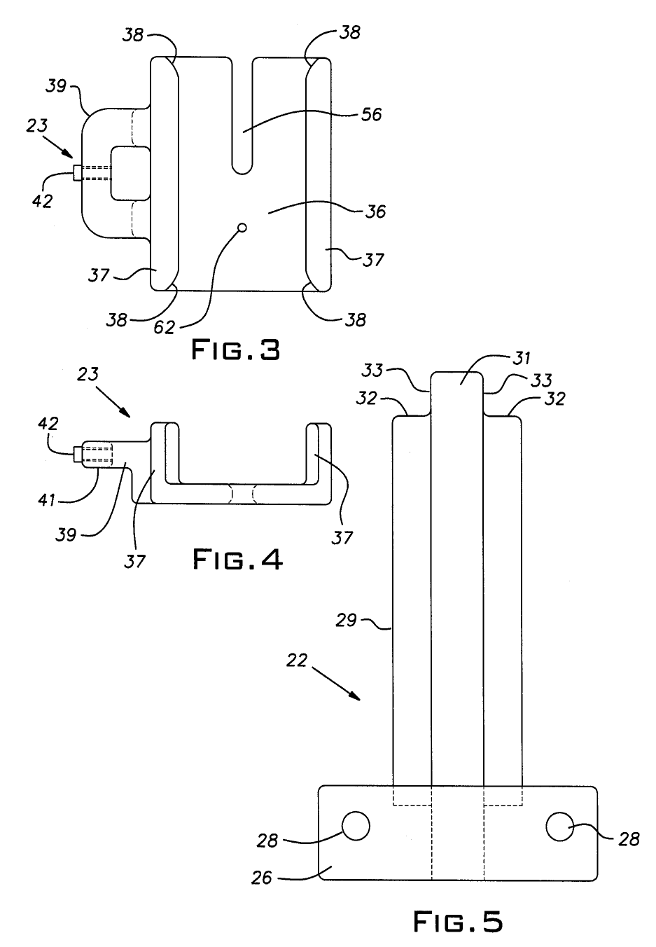

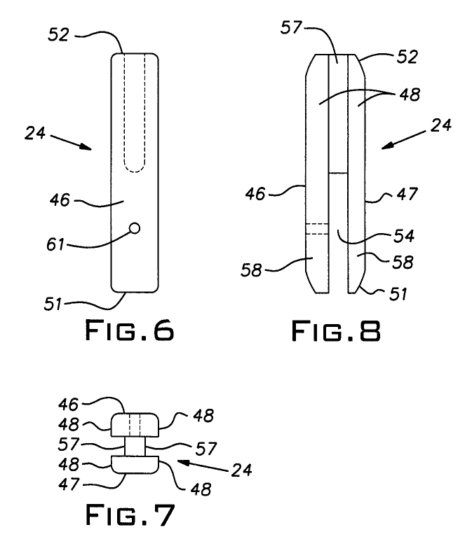

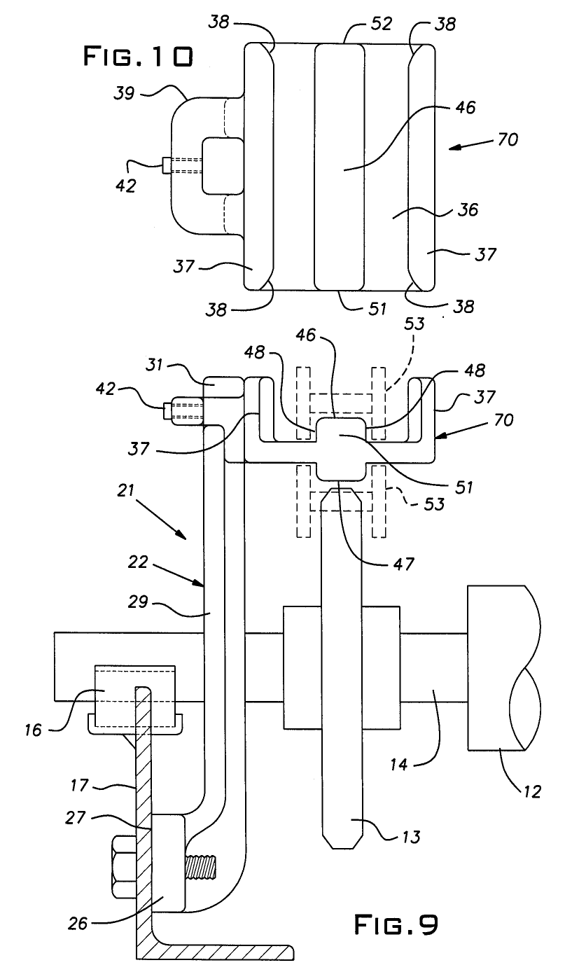

FIGS. 9 and 10 illustrate a second embodiment of the invention in which a wear bar 70 is integrally formed, such as by casting, with elements serving the functions of the guide 23 of the previously disclosed embodiment. The same reference numerals as applied to the elements of the first embodiment of FIGS. 1-7 are used where the function and/or structure is essentially the same. The wear bar 70 is preferably cast steel with a typical Rockwell hardness value of R_{c}55. The integrated wear bar 70 couples with the gooseneck support mounting bracket 21 by receiving the mounting lug or post 31 when the wear bar is vertically lowered onto the same. The gooseneck mounting bracket or support 22, as disclosed above in connection with the embodiment of FIGS. 1-7, serves as an adaptor for the wear bar 70 in the sense that it is fixed to the permanent cage angle or equivalent frame element 17 of the conveyor 11 and functions to support the wear bar on the cage angle.

The mutually engaged coupling surfaces between the mounting bracket 22 and wear bar 70, represented by the vertical sides 33 and shoulder surfaces 32 of the bracket mounting lug or post 31 and the internal vertical sides of the rectangular hole formed by the U-shaped bracket 39 in combination with the threaded locking screw or bolt 42 register and fix the wear bar in its operational position.

It will be seen that the geometries of the mounting bracket lug 31 and U-shaped bracket 39 cooperate to make for a quick change mounting of the wear bar 70. Only the single screw or bolt 42 need be loosened to remove a worn wear bar and be tightened to install a new wear bar. Tightening of the locking screw 42 automatically eliminates any positional ambiguity or looseness that the mutual indexing surfaces of the wear bar 70 and bracket 22 allow. The mounting bracket or support 22, constituting a separate rigid body interposed between the conveyor frame element 17 and the wear bar 70 is configured when the locking screw is tightened to locate the wear bar in a proper position relative to the desired path of the chain 18 as it engages with the sprockets 13. The wear bar 70 with the integrated guide elements, like the wear bar of the embodiment of FIGS. 1-7, can be replaced at considerable savings compared to prior art arrangements, since the gooseneck mounting bracket 22 need not be replaced. Preferably, the wear bar 70 is made of cast steel with a Rockwell hardness of, for example, about R_{c}55. This preferred hardness is less than that of the chain rollers at about Rockwell R_{c}60 and greater than the hardness of the gooseneck bracket 22, typically ductile cast iron at about Rockwell R_{c}35-40. The cast steel composition of the wear bar 70 yields a prolonged service life, as a chain is dragged over its surfaces, compared to prior art components made of ductile cast iron. The gooseneck bracket 22, not being subject to wear, can be of a relatively softer, less expensive ductile cast iron.

While the invention has been shown and described with respect to particular embodiments thereof, this is for the purpose of illustration rather than limitation, and other variations and modifications of the specific embodiments herein shown and described will be apparent to those skilled in the art all within the intended spirit and scope of the invention. Accordingly, the patent is not to be limited in scope and effect to the specific embodiments herein shown and described nor in any other way that is inconsistent with the extent to which the progress in the art has been advanced by the invention.

What is claimed is:

1. A hold down device for positioning the drive chain of a roller conveyor in a dryer comprising a mounting bracket, a guide and a wear bar, the mounting bracket being arranged to be mounted on a horizontally extending rigid frame member and having a configuration enabling it to support the guide over the path of the reach of a roller chain that is meshed with drive sprockets that are each associated with a respective roller of the conveyor, the guide being arranged to locate the wear bar in an operative position immediately overlying the chain while the chain is meshed with the roller sprockets, the wear bar being removably mounted on the guide, the guide bar being an elongated element having a width adapted to be received in the space between a pair of links separated by a roller of the drive chain.

2. A hold down device as set forth in claim 1, wherein the wear bar has a length at least as great as a pitch of the chain whereby at least one roller of the chain is supported by the hold down device.

3. A hold down device as set forth in claim 1, wherein the guide and wear bar are configured such that in the installed position of the wear bar it is capable of vertically supporting a portion of a return reach of an endless roller chain driving a series of sprockets of an overlying conveyor deck, the wear bar being removably mounted on the guide.

4. A hold down device as set forth in claim 1, wherein the guide includes vertically extending flanges parallel to and laterally spaced on opposite sides of the wear bar.

5. A hold down device as set forth in claim 5, wherein said flanges are adapted to laterally restrain the chain against excessive excursions from a path overlying the sprockets.

6. A hold down device as set forth in claim 4, wherein the guide is removably mounted on the mounting bracket.

7. A hold down device as set forth in claim 6, wherein the guide has a slot and said wear bar is received in said slot.

8. A hold down device as set forth in claim 6, wherein said wear bar has a slot and said guide is received in said wear bar slot.

9. A hold down device as set forth in claim 8, wherein said slot in the wear bar is elongated and parallel to a longitudinal direction of the wear bar.

10. A hold down device as set forth in claim 9, wherein said guide and wear bar slots are in alignment when the wear bar is mounted on the guide.

11. A hold down device as set forth in claim 7, wherein a portion of the length of the wear bar has grooves formed in and extending along opposite longitudinal sides of the wear bar parallel to a longitudinal direction of the wear bar, the grooves being proportioned to receive areas of the guide surrounding the slot in the guide.

12. A hold down device as set forth in claim 11, wherein said wear bar has an I-shaped cross-section transverse to the longitudinal direction of the wear bar in said portion.

13. A hold down device as set forth in claim 12, wherein the I-shaped cross-section has a relatively thicker flange on one side of a central web and a relatively thinner flange on the opposite side of the central flange whereby the wear bar can be assembled in either of two orientations with the heavier flange up or down to suit a particular dryer application.

14. A metal wear bar having an elongated body with a first cross-section associated with one longitudinal end and a second section associated with an opposite longitudinal end, the cross-sections having profiles with zones that lie generally in common imaginary planes extending parallel or perpendicular to one another, one longitudinal end of the wear bar being split so that it has a pair of longitudinally extending tines, and an elongate slot between the tines, the other longitudinal end of the wear bar having a pair of longitudinal extending grooves on opposite sides, the grooves lying generally in the same plane as the slot between the tines.

15. A metal wear bar as set forth in claim 14, wherein the tine end and grooved end each comprise approximately one-half the length of the wear bar.

16. A metal wear bar as set forth in claim 15, wherein the longitudinal ends are rounded or chamfered to prevent snagging of a chain.

17. A metal wear bar as set forth in claim 16, wherein the vertical height of said wear bar is generally uniform apart from its longitudinal ends.

18. A wear bar as set forth in claim 17, wherein the slot and grooves have generally the same vertical height.

19. A metal wear bar as set forth in claim 18, wherein the vertical height of the groove and slots is about less than one-third of the height of the wear bar.

20. A hold down device for a chain operating a roller conveyor comprising a support bracket and a wear bar, the support bracket having a vertical face and a pair of horizontally spaced mounting holes in the face for receiving bolts assembled through aligned holes in a frame element of the conveyor, the support bracket having wear bar coupling surfaces remote from its vertical faces, the wear bar having mounting surfaces configured to mate with the support bracket coupling surfaces, and a locking element for releasably locking the wear bar in an operative position on the support bracket with the respective mounting and coupling surfaces interengaged.

21. A hold down device as set forth in claim 20, wherein the mounting surfaces and coupling surfaces are arranged to permit the wear bar to be lowered vertically onto the support bracket.

22. A hold down device as set forth in claim 21, wherein the coupling surfaces are partially formed by an upstanding post of generally rectangular cross-section and which is an integral part of the support bracket.

23. A hold down device as set forth in claim 22, wherein the mounting surfaces are arranged in a rectangular array complementary to the shape of the support bracket post.

24. A hold down device as set forth in claim 23, wherein the wear bar is constructed of a material having a hardness of about Rockwell R_{c}55.
